(19) United States
(12) Patent Application Publication
(10) Pub. No.: US 2023/0048976 A1
(43) Pub. Date: Feb. 16, 2023

(54) DATA TRANSMISSION METHOD AND APPARATUS, COMMUNICATION DEVICE, AND STORAGE MEDIUM

(71) Applicant: BEIJING XIAOMI MOBILE SOFTWARE CO., LTD., Beijing (CN)

(72) Inventor: Yuanyuan LI, Beijing (CN)

(21) Appl. No.: 17/793,884

(22) PCT Filed: Jan. 20, 2020
(86) PCT No.: PCT/CN2020/073337

§ 371 Date: Jul. 19, 2022

(51) Int. Cl. H04L 5/00; H04W 72/10

(52) U.S. Cl. CPC H04L 5/0035; H04W 72/10; H04L 5/0051

(57) ABSTRACT

A data transmission method is provided. Measurement information associated with an inter-frequency signal measurement is received. The measurement information is configured to indicate at least one measurement window. First scheduling information associated with a first semi-persistent scheduling (SPS) physical downlink shared channel (PDSCH) resource is received. The first scheduling information is configured to indicate the first SPS PDSCH resource configured with a first priority. On the basis of the measurement information and the first scheduling information, it is determined that the first SPS PDSCH resource overlaps the measurement window in the time domain. In response to determining that the first SPS PDSCH resource overlaps the measurement window in the time domain, downlink communication with a serving cell is kept during at least the window of the first SPS PDSCH resource.

### CROSS-REFERENCE TO RELATED APPLICATION

This application is a U.S. national phase application of International Application No. PCT/CN2020/073337, filed on Jan. 20, 2020, the content of which is hereby incorporated by reference in its entirety for all purposes.

### TECHNICAL FIELD

The disclosure relates to, but is not limited to, a field of wireless communication technologies, and more particularly, to a data communication method, a data communication apparatus, a communication device, and a storage medium.

### BACKGROUND

In the fifth generation (5G, 5^{th} Generation) cellular mobile communication technology New Radio (NR) system, when performing mobility measurement, the user equipment (UE) may periodically measure reference signals of neighboring cells. In the case that the receiver bandwidth of the UE is not wide enough to cover both the carrier frequency of the serving cell and the carrier frequency of the neighboring cells, the UE can measure the neighboring cells at a certain time interval, and the base station can configure the measurement gap of the inter-frequency measurement for the UE. For example, the measurement gap repetition period is 40 ms, the measurement gap length is 6 ms, and the measurement gap offset is 20 ms. In this case, the measurement gap is at 20˜25 ms, 60-65 ms and 100-105 ms. Here, the neighboring cells may be referred to as inter-frequency cells.

For the inter-frequency cells, the UE may also monitor the Synchronized Signal Block (SSB) of the inter-frequency cells. The base station can set the SSB Measurement Timing Configuration (SMTC) for the UE. Setting the SMTC includes setting the monitoring period, the offset, the duration, and the cell identity (ID) of the monitored SSB. The UE will monitor the SSB of the inter-frequency cells within the specified duration. For example, the monitoring period is 80 ms, the offset is 40 ms, and the duration is 5 ms. In this case, the UE will monitor the SSB of the neighboring cells at 40˜44 ms, 120˜124 ms, 200˜204 ms, and so on.

### SUMMARY

According to a first aspect of embodiments of the disclosure, there is provided a data transmission method, including:

receiving measurement information associated with an inter-frequency signal measurement, in which the measurement information is configured to indicate at least one measurement window;

receiving first scheduling information associated with a first semi-persistent scheduling (SPS) physical downlink shared channel (PDSCH) resource, in which the first scheduling information is configured to indicate the first SPS PDSCH resource configured with a first priority;

determining that the first SPS PDSCH resource overlaps the measurement window in time domain based on the measurement information and the first scheduling information; and

keeping downlink communication with a serving cell at least on a window of the first PSP PDSCH resource in response to determining that the first SPS PDSCH resource overlaps the measurement window in the time domain.

According to a second aspect of embodiments of the disclosure, there is provided a data transmission method, including:

determining measurement information associated with inter-frequency signal measurement, in which the measurement information is configured to indicate at least one measurement window;

determining first scheduling information associated with a first semi-persistent scheduling (SPS) physical downlink shared channel (PDSCH) resource, in which the first scheduling information is configured to indicate the first SPS PDSCH resource configured with a first priority;

determining that the first SPS PDSCH resource overlaps the measurement window in time domain based on the measurement information and the first scheduling information; and

keeping downlink communication with a user equipment (UE) at least on a window of the first PSP PDSCH resource in response to determining that the first SPS PDSCH resource overlaps the measurement window in the time domain.

According to a third aspect of embodiments of the disclosure, there is provided a communication device, including a processor, a transceiver, a memory, and a program stored on the memory and executable by the processor. When the processor runs the program, the processor is configured to perform a data transmission method according to the first aspect and the second aspect.

According to fourth aspect of embodiments of the disclosure, there is provided a storage medium, having an executable program stored thereon. When the executable program is performed by a processor, a data transmission method according to the first aspect and the second aspect is performed.

It should be understood that the foregoing general description and the following detailed description are examples and are explanatory only and are not limitations of the embodiments of the disclosure.

### BRIEF DESCRIPTION OF THE DRAWINGS

The accompanying drawings, which are incorporated in and constitute a part of this specification, illustrate embodiments consistent with the disclosure and serve to explain the principles of the embodiments of the disclosure together with the description.

FIG. 1 is a schematic diagram illustrating a data transmission system in accordance with an embodiment of the disclosure.

FIG. 2 is a flowchart illustrating a data transmission method in accordance with an embodiment of the disclosure.

FIG. 3 is a schematic diagram illustrating positions of transmission window and measurement window in accordance with an embodiment of the disclosure.

FIG. 4 is a schematic diagram illustrating positions of transmission window and measurement window in accordance with another embodiment of the disclosure.

FIG. 5 is a schematic diagram illustrating positions of transmission window and measurement window in accordance with still another embodiment of the disclosure.

FIG. 6 is a schematic diagram illustrating positions of transmission window and measurement window in accordance with yet another embodiment of the disclosure.

FIG. 7 is a schematic diagram illustrating positions of transmission window and measurement window in accordance with yet another embodiment of the disclosure.

FIG. 8 is a flowchart illustrating a data transmission method in accordance with an embodiment of the disclosure.

FIG. 9 is a block diagram illustrating a data transmission apparatus in accordance with an embodiment of the disclosure.

FIG. 10 is a block diagram illustrating a data transmission apparatus in accordance with another embodiment of the disclosure.

FIG. 11 is a block diagram illustrating a data transmission device in accordance with an embodiment of the disclosure.

### DETAILED DESCRIPTION

Embodiments will be described in detail herein, examples of which are illustrated in the accompanying drawings. In the following description related to the drawings, the same numerals in different drawings refer to the same or similar elements unless otherwise indicated. The implementations described in the following embodiments do not represent all implementations consistent with embodiments of the disclosure. Rather, they are merely examples of apparatus and methods consistent with some aspects of embodiments of the disclosure as recited in the appended claims.

The terms used in the embodiments of the disclosure are only for the purpose of describing particular embodiments, and are not intended to limit the embodiments of the disclosure. As used in the embodiments of the description and the appended claims, the singular forms “a,” “an,” and “the” are intended to include the plural forms as well, unless the context clearly dictates otherwise. It is understandable that the term “and/or” as used herein refers to and includes any one and all possible combinations of one or more of the associated listed items.

It is understandable that although the terms first, second, third, etc. may be used in embodiments of the disclosure to describe various pieces of information, such information should not be limited to these terms. These terms are only used to distinguish the same type of information from each other. For example, the first information may also be referred to as the second information, and similarly, the second information may also be referred to as the first information without departing from the scope of the embodiments of the disclosure. Depending on the context, the word “if” as used herein can be interpreted as “at the time of” or “when” or “in response to determining.”

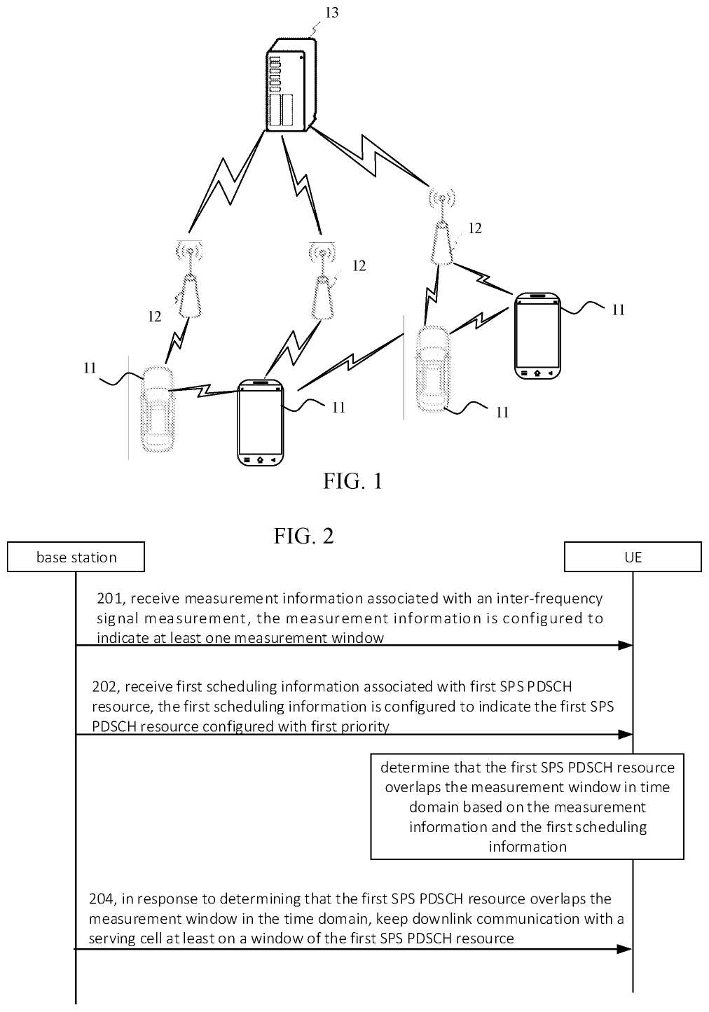

FIG. 1 is a schematic diagram illustrating a wireless communication system in accordance with an embodiment of the disclosure. As illustrated in FIG. 1, the wireless communication system is a communication system based on the cellular mobile communication technology. The wireless communication system may include several terminals 11 and several base stations 12.

The terminal 11 may be a device that provides voice and/or data connectivity to the user. The terminal 11 may communicate with one or more core networks via a Radio Access Network (RAN). The terminal 11 may be an Internet of Thing (IoT) terminal such as a sensor device, a mobile phone (or “cellular” phone), or a computer with an IoT terminal, such as a fixed device, a portable device, a pocket device, a hand-held device, a computer built-in device or a vehicle-mounted device. For example, Station (STA), subscriber unit, subscriber station, mobile station, mobile, remote station, access point, remote terminal, access terminal, user terminal, user agent, user device, or user equipment (UE). Alternatively, the terminal 11 may be a device of unmanned aerial vehicle. Alternatively, the terminal 11 may be a vehicle-mounted device, such as a trip computer with a wireless communication function, or a wireless communication device externally connected to the trip computer. Alternatively, the terminal 11 may be a roadside device, such as a street light, a traffic light, or other roadside devices with a wireless communication function.

The base station 12 may be a network-side device in the wireless communication system. The wireless communication system may be the 4th generation mobile communication (4G) system, also known as Long Term Evolution (LTE) system. Alternatively, the wireless communication system may be a 5th generation mobile communication (5G) system, also known as new radio (NR) system or 5G NR system. Alternatively, the wireless communication system may be a next-generation system of the 5G system. The access network in the 5G system may be called New Generation-Radio Access Network (NG-RAN). Alternatively, the wireless communication system can be a Machine Type Communication (MTC) system.

The base station 12 may be an evolved base station (eNB) of the 4G system. Alternatively, the base station 12 may be a base station (gNB) that adopts a centralized-distributed architecture of the 5G system. When adopting the centralized-distributed architecture, the base station 12 usually includes a central unit (CU) and at least two distributed units (DU). The central unit is provided with a protocol stack of Packet Data Convergence Protocol (PDCP), Radio Link Control (RLC), and Medium Access Control (MAC). The distributed unit is provided with a protocol stack of a physical (PHY) layer. Embodiments of the disclosure not limit the implementation form of the base station 12.

A wireless connection can be established between the base station 12 and the terminal 11 through a wireless air interface. In different implementations, the wireless air interface can be a wireless air interface based on the 4G or based on 5G, such as the wireless air interface or the new radio, or the wireless air interface can be a wireless air interface based on the next-generation of the 5G.

In some embodiments, an E2E (End to End) connection can be established between terminals 11. For example, Vehicle to Vehicle (V2V) communication, Vehicle to Infrastructure (V2I) and Vehicle to Pedestrian (V2P) communication in the Vehicle to Everything (V2X) communication.

In some embodiments, the above wireless communication system may also include a network management device 13.

The base stations 12 are respectively connected to the network management device 13. The network management device 13 may be a core network device in the wireless communication system. As an example, the network management device 13 may be a Mobility Management Entity (MME) in an Evolved Packet Core (EPC). As another example, the network management device can be another core network device, such as Serving GateWay (SGW), Public Data Network GateWay (PGW), Policy and Charging Rules Function (PCRF), or Home Subscriber Sserver (HSS), etc. Embodiments of the disclosure do not limit the implementation form of the network management device 13.

The execution subject involved in the embodiments of the disclosure includes, but is not limited to, the terminal or the base station that communicate through the 5G technology.

An use scenario of the embodiments of the disclosure is that, in the case that the receiver bandwidth of the UE is not wide enough to cover both the serving carrier frequency of the cell and the serving carrier frequency of the neighboring cells to be measured, the UE can measure the reference signals or the like of the neighboring cells at a certain measurement gap. During the measurement gap configured for the UE to perform the radio measurement on the neighboring cells to be measured, the normal data transmission and reception and possible intra-frequency measurement performed by the UE in the serving cell will be interrupted. After the measurement gap ends, the UE will return to the carrier frequency of the serving cell, and continue the normal data transmission and reception and the possible intra-frequency measurement.

If the receiver bandwidth of the UE is not wide enough to cover both the serving carrier frequency of the cell and the serving carrier frequency of the cell to be measured, the normal data transmission and reception between the UE and the serving cell will be interrupted and the SSB of the neighboring cell is measured during the configured SMTC duration window. After the window ends, the UE will return to the carrier frequency of the serving cell, and continue to perform the normal data transmission and reception.

In the 5G NR, some services require low latency, such as the Ultra Reliable and Low Latency Communication (URLLC) service. This type of services usually requires that the transmitter can obtain transmission resources as soon as possible when there is data to be transmitted, to reduce the latency of the service caused by waiting in the buffer of the transmitter, thereby reducing the transmission latency of the air interface. When the UE measures the inter-frequency signal within the measurement gap or the/SMTC window, the receiver of the UE cannot receive the downlink information of the serving cell, thus causing a latency in data transmission.

Therefore, the disclosure provides a data transmission method, the UE receives the measurement information associated with the inter-frequency signal measurement, the measurement information is configured to indicate at least one measurement window. The UE receives the first scheduling information associated with the first SPS PDSCH resource. The first scheduling information is configured to indicate the first SPS PDSCH resource configured with a first priority. The UE determines that the first SPS PDSCH resource overlaps the measurement window in the time domain based on the measurement information and the first scheduling information. The UE keeps the downlink communication with the serving cell at least on the window of the first SPS PDSCH resource in response to determining that the first SPS PDSCH resource overlaps the measurement window in the time domain. Generally, if the receiver bandwidth of the UE is insufficient to cover both the carrier frequency of the serving cell and the carrier frequency of the inter-frequency cell, the UE will stop receiving the downlink data and perform the inter-frequency signal measurement, thereby improving the latency of receiving the downlink data. With the method in accordance with embodiments of the disclosure, the UE can receive the downlink signal of the serving cell within the measurement window of the inter-frequency signal measurement, thereby reducing the happening of the situation that the downlink data transmission is stopped due to the inter-frequency signal measurement, reducing the transmission latency of the downlink signal, and meeting the low-latency requirement of the data transmission.

As illustrated in FIG. 2, a data transmission method is provided, which can be performed by a UE of a wireless communication. The method includes the following.

At block 201, measurement information associated with inter-frequency signal measurement. The measurement information is configured to indicate at least one measurement window.

At block 202, first scheduling information associated with a first semi-persistent scheduling (SPS) physical downlink shared channel (PDSCH) resource. The first scheduling information is configured to indicate that the first SPS PDSCH resource is configured with a first priority.

At block 203, it is determined whether the first SPS PDSCH resource overlaps the measurement window based on the measurement window and the first scheduling information.

At block 204, in response to determining that the first SPS PDSCH resource overlaps the measurement window in the time domain, a downlink communication with a serving cell is kept at least within a window of the first SPS PDSCH resource.

The measurement window may be the above-mentioned measurement gap. The inter-frequency signal may be a signal having a center frequency different from the center frequency of the serving cell where the UE is currently located. Alternatively, the inter-frequency signal refers to a signal of an inter-frequency cell occupying a band width part (BWP) different from the BWP currently occupied UE. Alternatively, the inter-frequency signal refers to a signal an inter-frequency cell having a different center frequency or a different sub-carrier space (SCS) in the SSB measurement. The inter-frequency signal measurement refers to performing signal quality measurement on the inter-frequency signal or monitoring the inter-frequency signal.

Here, keeping the downlink communication with the serving cell may include that the UE receives a downlink signal sent by the serving cell to the UE through the downlink or the UE monitors the downlink signal in the serving cell on the downlink. The downlink signal includes, but is not limited to, control instructions and downlink data sent by the serving cell to the UE.

Similarly, keeping the downlink communication with the UE may include that the serving cell sends the downlink signal to the UE through the downlink when needed or the serving cell keeps the downlink connection with the UE.

In the SPS mode, after the UE applies for a transmission resource once, the corresponding transmission resource will be periodically allocated to the UE within a period of time. The base station configures periodic downlink transmission resources for the UE. The SPS PDSCH resource may be the periodic PDSCH resource configured by the base station in the serving cell for downlink communication. The UE may receive the downlink data in the serving cell using the SPS PDSCH resource.

Here, the first scheduling information may be scheduling information for configuring the SPS PDSCH resource and/or for activating the SPS PDSCH resource. The base station may configure the SPS PDSCH resource for the UE, and when performing the data transmission, the base station can activate the configured SPS PDSCH resource for the data transmission. For example, the SPS PDSCH resource configuration can be configured by the base station through the first scheduling information, and only the value of the period in the configuration is configured. For example, the value of the period is 1 ms. It is possible that the start position of the SPS PDSCH resource in the time domain is not configured by the first scheduling information. The base station may activate the SPS PDSCH resource configuration through the first scheduling information, and may indicate the specific time-frequency position of the first SPS PDSCH resource. For example, the first scheduling information for the activation is sent on a slot n, indicating that the first SPS PDSCH resource is the symbols 2 to 5 of the slot n+1. In this way, the SPS PDSCH resource may be the transmission resource of symbols 2 to 5 of each slot with a period of 1 millisecond (ms). The first scheduling information may be a radio resource control (RRC) configuration signaling and/or downlink control information (DCI).

If the receiver bandwidth of the UE is insufficient to cover both the carrier frequency of serving cell and the carrier frequency of the inter-frequency cell, the UE cannot perform the inter-frequency signal measurement of the inter-frequency cell and the data transmission of the serving cell at the same time. For example, the UE cannot perform the inter-frequency signal measurement and the downlink communication with the serving cell simultaneously during the measurement gap or the UE cannot perform the inter-frequency signal monitoring and receive the downlink signal in the serving cell simultaneously during the configured SMTC duration. The SPS PDSCH resource having the first priority can be configured to transmit the downlink data that requires a low latency, such as the URLLC service data. The first priority is higher than a second priority. The SPS PDSCH resource having the second priority can be configured to transmit the downlink data whose transmission latency requirements are relatively lower than the downlink data transmitted by the SPS PDSCH resource having the first priority, such as the Massive Machine Type Communications (mMTC) service data that the transmission delay requirements are lower than those of URLLC service data. The priority of the SPS PDSCH resource can be configured by the base station through the RRC signaling.

Since both the window of the PDSCH resource scheduled by the SPS mode and the measurement window of inter-frequency signal measurement can be configured by the base station, and the base station uses the RRC signaling or the like to deliver the transmission window and measurement window to the UE, both the base station and the UE may determine in advance whether there is the SPS PDSCH resource having the first priority for transmitting the downlink data within the measurement window of the inter-frequency signal measurement. In response to determining that there is the SPS PDSCH resource having the first priority for transmitting the downlink data within the measurement window of the inter-frequency signal measurement, the UE may stop performing the inter-frequency signal measurement. Stopping the inter-frequency signal measurement may be stopping all the inter-frequency signal measurements within the measurement window, or stopping the inter-frequency signal measurements within the transmission window occupied by the SPS PDSCH resource having the first priority.

The base station may send the first scheduling information indicating the first SPS PDSCH resource configured with the first priority and the measurement information indicating at least one measurement window to the UE. The UE may determine the priority of the first SPS PDSCH resource based on the first scheduling information and determine the measurement window based on the measurement information.

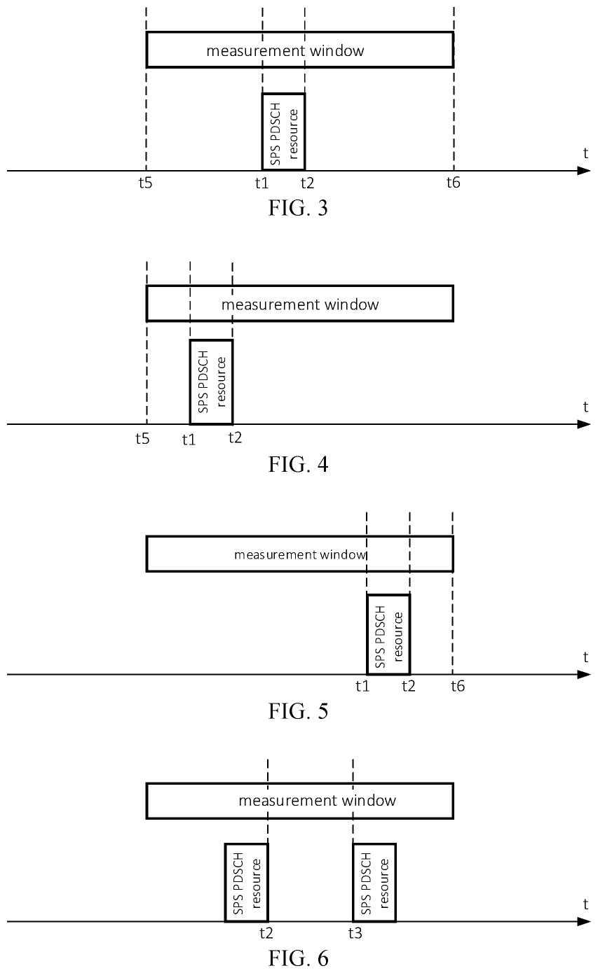

As illustrated in FIG. 3, when the window of the SPS PDSCH resource having the first priority is within the measurement window of the inter-frequency signal measurement performed by the UE, that is, the start time t1 of the SPS PDSCH resource is later than or equal to the start time of the measurement window t5 and the end time t2 of the SPS PDSCH resource is earlier than or equal to the end time t6 of the measurement window, the UE may stop the inter-frequency signal measurement on the SPS PDSCH resource having the first priority. The UE may perform the inter-frequency signal measurement on resources other than the SPS PDSCH resource. The base station can keep transmitting the downlink data within the window of the SPS PDSCH resource having the first priority, not avoiding the measurement window of the inter-frequency signal measurement.

In this way, with the method in accordance with embodiments of the disclosure, the UE can receive the downlink signal of the serving cell within the measurement window of the inter-frequency signal measurement, thereby reducing the situation that the downlink signal transmission is stopped due to the inter-frequency signal measurement, reducing the transmission delay of the downlink signal, and meeting the requirements of low-latency data transmission.

The inter-frequency signal measurement includes reference signal measurement performed by the UE on the inter-frequency cell and/or synchronization signal block (SSB) monitoring performed by the UE on the inter-frequency cell.

The measurement window during which the UE performs the inter-frequency signal measurement on the inter-frequency cell includes the measurement window during which the UE performs reference signal measurement on the inter-frequency cell and/or the duration window during which the UE performs SSB monitoring on the inter-frequency cell.

Here, the reference signal measurement may be that the UE measures a reference signal of an inter-frequency cell when performing mobility measurement. The UE may measure the reference signal of the inter-frequency cell at intervals. The base station may configure the periodic measurement gap for the UE. The UE may stop the reference signal measurement when performing the downlink SPS data transmission having the first priority.

The base station may configure a periodic duration window for the UE to monitor the SSB of the inter-frequency cell. The UE may stop monitoring the SSB of the inter-frequency cell when performing the downlink SPS data transmission having the first priority.

In some embodiments, the block 204 may include determining that a time difference between the start time of the measurement window and the start time of one of the at least one first SPS PDSCH resource is less than or equal to a time length threshold; keeping the downlink communication with the serving cell during a time period between the start time of the measurement window and the start time of the one of the at least one SPS PDSCH resource; and performing the inter-frequency signal measurement after the window of the one of the at least one SPS PDSCH resource.

Here, the one of the at least one first SPS PDSCH resource may be any one of the at least one first SPS PDSCH resource within the measurement window, or may be the first one of the at least one first SPS PDSCH resource within the measurement window.

Since the receiver of the UE needs a certain handover time period for the handover between the carrier frequency of the serving cell and the carrier frequency of the inter-frequency cell, within is a time duration that the UE perform the carrier frequency handover once, when the time period between the start time of the measurement window and the start time of the first SPS PDSCH resource is less than the twice of the handover time period, the UE cannot return back to the carrier frequency of the serving cell during this time period, and thus the UE cannot complete the handover process. This results in useless handover operations and even delays in the downlink data transmission on the first SPS PDSCH resource. Therefore, in order to avoid the above situation, the base station may configure the time length threshold based on at least the handover time period. The time length threshold may be greater than or equal to the twice of the handover time period. In some examples, the base station can configure the time length threshold based on factors other than the carrier frequency handover time period of the UE. The other factors include, for example, resource configuration status of the system, global configuration of the base station, channel quality, and the like. Here, keeping the downlink communication with the serving cell may be that the receiver of the UE keeps the downlink communication with the serving cell without monitoring the signal of the inter-frequency cell.

As illustrated in FIG. 4, the SPS PDSCH resource having the first priority is within the measurement window during which the UE performs the inter-frequency signal measurement and the time difference from the start time t5 of the measurement window to the start time t1 of the SPS PDSCH resource is less than or equal to the time length threshold. In the case that the inter-frequency signal measurement is performed between t5 and t1, since the UE needs to perform the carrier frequency handover twice, considering the time required for the inter-frequency signal measurement and the inter-frequency handover time period of the UE, it may be determined that the UE cannot switch to the carrier frequency of the serving cell for the downlink communication from the start time t5. Therefore, when the time difference between the start time t5 of the measurement window to the start time t1 of the SPS PDSCH resource is less than or equal to the time length threshold, the UE will keep receiving the downlink information in the serving cell during the time period from t5 to t1, without performing the inter-frequency signal measurement, and the UE can perform the inter-frequency signal measurement after the end time t2 of the transmission window.

In this way, happening of the case that the UE cannot switch to the carrier frequency of the serving cell timely from the start time of the SPS PDSCH resource caused by performing the handover between the carrier frequency of the inter-frequency cell and the carrier frequency of the serving cell before the first SPS PDSCH resource can be reduced. Therefore, the reliability of the downlink data reception during the transmission window can be improved and invalid carrier frequency handover can be reduced.

In some embodiments, the block 204 may include in response to determining that the time difference between the end time of the measurement window and the end time of one of the at least one first SPS PDSCH resource is less than or equal to the time length threshold, keeping the downlink communication with the serving cell during the time period between the end time of the one of the at least one first SPS PDSCH resource and the end time of the measurement window.

Here, the one of the at least one first SPS PDSCH resource may be any one or the last one of the at least one first SPS PDSCH resource within the measurement window.

In the case that the time period between the end time of the measurement window and the end time of the SPS PDSCH resource is less than or equal to the time length threshold, since the UE needs to perform the carrier frequency handover twice, after performing inter-frequency signal measurement within this time period, it is determined that there is no enough time for the UE to switch to the carrier frequency of the serving cell at the end of the measurement window. Therefore, the UE can keep receiving the downlink information in the serving cell during this window, without performing inter-frequency signal measurement.

As illustrated in FIG. 5, the SPS PDSCH resource is within the measurement window during which the UE performs the inter-frequency signal measurement and the time period from the end time t2 of the SPS PDSCH resource to the end time t6 of the measurement window is less than or equal to the time length threshold. If the inter-frequency signal measurement is performed from t2 to t6, since the UE needs to perform the carrier frequency handover twice, considering the time period occupied by the inter-frequency signal measurement and the inter-frequency handover time period of the UE, it can be determined that the UE cannot switch to the carrier frequency of the serving cell at t6. Therefore, when the time period from the end time t2 of the SPS PDSCH resource to the end time t6 of the measurement window is less than or equal to the inter-frequency handover time period of the UE, the UE can keep receiving the downlink information in the serving cell from t2 to t6, and does not perform the inter-frequency signal measurement.

In this way, the happening of the case that the UE cannot switch to the carrier frequency of the serving cell timely for the downlink communication after the end of the measurement window caused by performing the inter-frequency signal measurement and the downlink communication handover from the end time of the measurement window to the end time of the SPS PDSCH resource. In addition, the invalid carrier frequency handover can be reduced.

In some embodiments, the block 204 may include in response to determining that a time period between two adjacent first SPS PDSCH resources of at least two first SPS PDSCH resources within the measurement window is less than or equal to the time length threshold, keeping the downlink communication with the serving cell during the time period.

There may be two or more SPS PDSCH resources within one measurement window. During the time period between two adjacent SPS PDSCH resources, if it needs to perform the inter-frequency signal measurement, the UE needs to switch from the carrier frequency of the serving cell to the carrier frequency of the inter-frequency cell, performs the inter-frequency signal measurement, and switches from the carrier frequency of the inter-frequency cell to the carrier frequency of the serving cell for the downlink communication. Therefore, the UE requires a certain handover time period. The UE or the base station may set the time length threshold to be greater than or equal to the twice of the handover time period. If the time period left for the UE to perform the carrier frequency handover twice is less than or equal to the time length threshold, it is determined that the UE cannot complete the carrier frequency handover twice when the time period ends. Therefore, if the time period between two SPS PDSCH resources is less than or equal to the time length threshold, the UE keeps the downlink communication with the serving cell without performing the inter-frequency signal measurement.

As illustrated in FIG. 6, multiple SPS PDSCH resources are within the measurement window during which the UE performs the inter-frequency signal measurement. In the two adjacent SPS PDSCH resources, the time period from the end time t2 of the earlier SPS PDSCH resource to the start time t3 of the later SPS PDSCH resource is less than or equal to the time length threshold. If the inter-frequency signal measurement is performed between t2 and t3, considering the time period occupied by the inter-frequency signal measurement and the time period of performing the carrier frequency handover twice by the UE, it can be determined that the UE cannot switch to the carrier frequency of the serving cell for the downlink communication at t3. Therefore, the UE can keep receiving downlink information in the serving cell during the time period from t2 to t3, without performing the inter-frequency signal measurement.

In this way, the happening of the case that the UE cannot switch to the carrier frequency of the serving cell in time after the time period between the two adjacent SPS PDSCH ends caused by performing the handover between the carrier frequency of the inter-infrequency cell and the carrier frequency of the serving cell during the time period between the two adjacent SPS PDSCH resources. At the same time, invalid carrier frequency handover can be reduced.

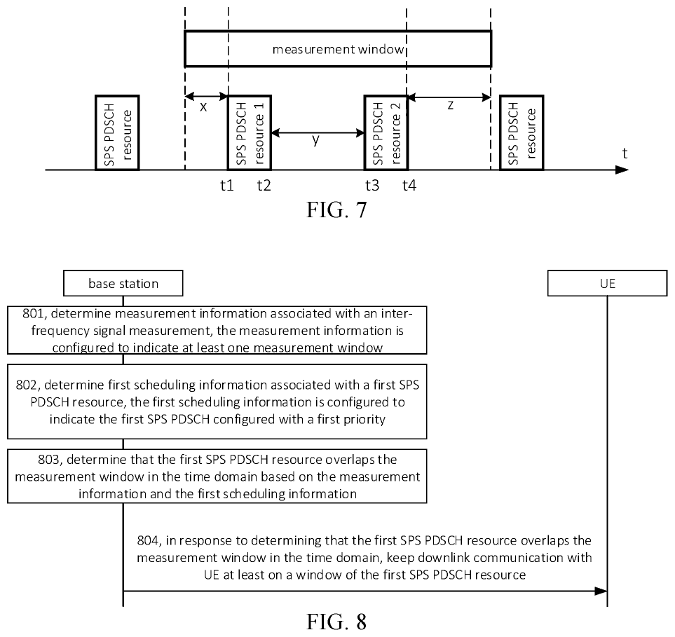

As illustrated in FIG. 7, there are two SPS PDSCH resources within the measurement window during which the UE performs the inter-frequency signal measurement.

In FIG. 7, X represents the time period from the start time of a first one of the transmission windows occupied by the two SPS PDSCH resources to the start time of the measurement window. In the case that X is less than or equal to the time length threshold, the inter-frequency signal measurement is performed after the first transmission window. That is, the UE keeps the downlink communication with the serving cell within the time period X, without performing the inter-frequency signal measurement.

In FIG. 7, Y represents the time period from the end time of the first one of the two SPS PDSCH resources to the start time of the second one of the two SPS PDSCH resources. In the case that Y is less than or equal to the time length threshold, the UE keeps the downlink communication with the serving cell during the time period Y, without performing the inter-frequency signal measurement.

In FIG. 7, Z represents the time period from the end time of the second one of the two SPS PDSCH resources to the end time of the measurement window. In the case that Z is less than or equal to the time length threshold, the inter-frequency signal measurement is not performed after the second SPS PDSCH resource. That is, the UE keeps the downlink communication with the serving cell during the time period Z, without performing the inter-frequency signal measurement.

In some embodiments, the time length threshold is greater than or equal to the time period that the UE performs the inter-frequency handovers twice.

In the process that the UE switches from the downlink signal received by the serving cell to the carrier frequency of the inter-frequency cell for the inter-frequency signal measurement and then to the downlink signal received by the serving cell, the receiver needs to switch from the carrier frequency of the serving cell to the carrier frequency of the inter-frequency cell, and the UE needs to configure the receiver. The time length threshold may be greater than or equal to the twice of the inter-frequency handover time period of the UE.

During the time period between two adjacent transmission windows, the UE needs to switch from the carrier frequency of the serving cell to the carrier frequency of the inter-frequency cell, performs the inter-frequency signal measurement, and switches from the carrier frequency of the inter-frequency cell to the carrier frequency of the serving cell. Therefore, the UE needs the twice of the inter-frequency handover time period. The time length threshold may be greater than or equal to the twice of the inter-frequency handover time period of the UE.

The time length threshold is greater than or equal to the time period that the UE performs the inter-frequency handover twice. It can be determined that the UE can complete the carrier frequency handover twice.

In this way, the time length threshold is used as the condition for determining whether to perform the handover between the carrier frequency of the inter-frequency cell and the carrier frequency of the serving cell, it may be accurately determined whether there is enough time for the UE to perform the carrier frequency handover between the inter-frequency cell and the serving cell. Therefore, invalid carrier frequency handover can be reduced and it can be ensured that the UE can switch to the carrier frequency of the serving cell for the data transmission within the transmission window or the UE can switch to the carrier frequency of the inter-frequency cell to perform the inter-frequency signal measurement within the measurement window.

In some embodiments, the data transmission method may further include receiving indication information configured to indicate the time length threshold.

Here, the time length threshold may be determined by the base station and sent to the UE through the indication information.

In some embodiments, the data transmission method may further include reporting capability information of the UE. The capability information is used for the base station to determine the time length threshold.

The UE can send the capability information, such as the time period required for performing the carrier frequency handover by the UE, to the base station. The base station may determine the inter-frequency handover time period based on the reported capability information, and send the determined time length threshold to the UE. The base station can separately assign the time length threshold for a UE or assign the determined time length threshold to multiple UEs.

In some embodiments, the data transmission method further includes receiving second scheduling information associated with a second SPS PDSCH resource, in which the second scheduling information is configured to indicate a second SPS PDSCH resource configured with a second priority and the first priority is higher than the second priority, determining, based on the measurement information and the second scheduling information, that the second SPS PDSCH resource overlaps the measurement window in the time domain; and in response to determining that the second SPS PDSCH resource overlaps the measurement window in the time domain, keeping the inter-frequency signal measurement on an overlapping portion where the second SPS PDSCH resource overlaps the measurement window in the time domain.

For the second SPS PDSCH resource having the second priority, the UE may perform the inter-frequency signal measurement within the measurement window.

In some embodiments, keeping the inter-frequency signal measurement on the overlapping portion where the second SPS PDSCH resource overlaps the measurement window in the time domain includes stopping the downlink communication with the serving cell on the overlapped portion where the second SPS PDSCH resource overlaps the measurement window in the time domain.

The base station may stop the downlink communication with the UE on the overlapping portion where the second SPS PDSCH resource overlaps the measurement window in the time domain.

The UE may not use the second SPS PDSCH resource to perform the downlink communication with the serving cell when performing the inter-frequency signal measurement within the measurement window.

In this way, the completion of the inter-frequency signal measurement can be within the measurement window can be ensured, and at the same time, the flexible configuration for the high-priority SPS PDSCH resource and the low-priority SPS PDSCH resource in the inter-frequency signal measurement scenario is achieved.

In some embodiments, the first SPS PDSCH resource is scheduled for a first communication service type. The first communication service type has a higher priority than a second communication service type.

For example, the priority of the URLLC service type is higher than the priority of the mMTC type, such that the first SPS PDSCH resource may be scheduled for the URLLC service type.

In this way, the service data with the higher priority can be not affected by the inter-frequency signal measurement, to reduce the time latency.

In some embodiments, the first SPS PDSCH resource is configured by the RRC signaling to have the first priority.

Here, the base station can configure the SPS PDSCH resource to have the first priority through the RRC signaling. The first priority may be the highest priority, or the first priority may be higher than a preset priority threshold.

For example, the URLLC service has high requirements on the low latency. Therefore, the SPS PDSCH resource used for the downlink data transmission of the URLLC service may be determined to have the first priority. The base station may send the downlink SPS PDSCH resource configuration information and the priority information corresponding to the downlink SPS PDSCH configuration to the UE through the RRC signaling. When the transmission window occupied by the SPS PDSCH resource having the first priority is within the measurement window, the downlink data transmission of the downlink SPS PDSCH having the first priority is performed. In this way, the time latency of the downlink data of the URLLC service can be reduced, and latency requirements of the downlink data transmission of the URLLC service is satisfied.

In some embodiments, keeping the downlink communication with the serving cell on the at least the first SPS PDSCH resource includes at least stopping the inter-frequency signal measurement on the overlapping portion where the first SPS PDSCH resource overlaps the measurement window in the time domain.

During the measurement window, the UE uses the first SPS PDSCH resource to receive the downlink data from the serving cell, and the UE stops performing the inter-frequency signal measurement within the window of the first SPS PDSCH resource.

In this way, the UE can perform the downlink communication with the serving cell within the measurement window of the inter-frequency signal measurement, thereby reducing the happening of the situation that the downlink communication is stopped due to the inter-frequency signal measurement, reducing the transmission delay of the downlink data, and satisfying the requirements for the low-latency data transmission.

As illustrated in FIG. 8, a data transmission method is provided, which is performed by a base station of a wireless communication. The method includes the following.

At block 801, measurement information associated with inter-frequency signal measurement is determined. The measurement information is configured to indicate at least one measurement window.

At block 802, first scheduling information associated with the first SPS PDSCH resource is determined. The first scheduling information is configured to indicate the first SPS PDSCH resource configured with a first priority.

At block 803, it is determined whether the first SPS PDSCH resource overlaps the measurement window in the time domain based on the measurement window and the first scheduling information.

At block 804, in response to determining that the first SPS PDSCH resource overlaps the measurement window in the time domain, downlink communication with the UE is kept at least within a window of the first SPS PDSCH resource.

The inter-frequency signal may be a signal having a center frequency different from the center frequency of the serving cell where the UE is currently located. Alternatively, the inter-frequency signal refers to a signal of an inter-frequency cell occupying a BWP different from the BWP currently occupied UE. Alternatively, the inter-frequency signal refers to a signal an inter-frequency cell having a different center frequency or a different sub-carrier space (SCS) in the SSB measurement. The inter-frequency signal measurement refers to performing signal quality measurement on the inter-frequency signal or monitoring the inter-frequency signal.

Here, keeping the downlink communication with the serving cell may include that the UE receives a downlink signal sent by the serving cell to the UE through the downlink or the UE monitors the downlink signal in the serving cell on the downlink. The downlink signal includes, but is not limited to, control instructions and downlink data sent by the serving cell to the UE.

Similarly, keeping the downlink communication with the UE may include that the serving cell sends the downlink signal to the UE through the downlink when needed or the serving cell keeps the downlink connection with the UE.

In the SPS mode, after the UE applies for a transmission resource once, the corresponding transmission resource will be periodically allocated to the UE within a period of time. The base station configures periodic downlink transmission resources for the UE. The SPS PDSCH resource may be the periodic PDSCH resource configured by the base station in the serving cell for downlink communication. The UE may receive the downlink data in the serving cell using the SPS PDSCH resource.

Here, the first scheduling information may be scheduling information for configuring the SPS PDSCH resource and/or for activating the SPS PDSCH resource. The base station may configure the SPS PDSCH resource for the UE, and when performing the data transmission, the base station can activate the configured SPS PDSCH resource for the data transmission. For example, the SPS PDSCH resource configuration can be configured by the base station through the first scheduling information, and only the value of the period in the configuration is configured. For example, the value of the period is 1 ms. It is possible that the start position of the SPS PDSCH resource in the time domain is not configured by the first scheduling information. The base station may activate the SPS PDSCH resource configuration through the first scheduling information, and may indicate the specific time-frequency position of the first SPS PDSCH resource. For example, the first scheduling information for the activation is sent on a slot n, indicating that the first SPS PDSCH resource is the symbols 2 to 5 of the slot n+1. In this way, the SPS PDSCH resource may be the transmission resource of symbols 2 to 5 of each slot with a period of 1 ms. The first scheduling information may be a radio resource control (RRC) and/or downlink control information (DCI).

If the receiver bandwidth of the UE is insufficient to cover both the carrier frequency of serving cell and the carrier frequency of the inter-frequency cell, the UE cannot perform the inter-frequency signal measurement of the inter-frequency cell and the downlink communication with the serving cell at the same time. For example, the UE cannot perform the inter-frequency signal measurement and the downlink communication with the serving cell simultaneously during the measurement gap or the UE cannot perform the inter-frequency signal monitoring and the downlink communication with the serving cell simultaneously during the configured SMTC duration. The SPS PDSCH resource having the first priority can be configured to transmit the downlink data that requires a low latency, such as the URLLC service data. The first priority is higher than a second priority. The SPS PDSCH resource having the second priority can be configured to transmit the downlink data whose transmission latency requirements are relatively lower than the downlink data transmitted by the SPS PDSCH resource having the first priority, such as the Massive Machine Type Communications (mMTC) service data that the transmission delay requirements are lower than those of URLLC service data. The priority of the SPS PDSCH resource can be configured by the base station through the RRC signaling.

Since both the window of the PDSCH resource scheduled by the SPS mode and the measurement window of inter-frequency signal measurement can be configured by the base station, and the base station uses the RRC signaling or the like to deliver the transmission window and measurement window to the UE, both the base station and the UE may determine in advance whether there is the SPS PDSCH resource having the first priority for transmitting the downlink data within the measurement window of the inter-frequency signal measurement. In response to determining that there is the SPS PDSCH resource having the first priority for transmitting the downlink data within the measurement window of the inter-frequency signal measurement, the UE may stop performing the inter-frequency signal measurement. Stopping the inter-frequency signal measurement may be stopping all the inter-frequency signal measurements within the measurement window, or stopping the inter-frequency signal measurements within the transmission window occupied by the SPS PDSCH resource having the first priority.

The base station may send the first scheduling information indicating the first SPS PDSCH resource configured with the first priority and the measurement information indicating at least one measurement window to the UE. The UE may determine the priority of the first SPS PDSCH resource based on the first scheduling information and determine the measurement window based on the measurement information.

As illustrated in FIG. 3, when the window of the SPS PDSCH resource having the first priority is within the measurement window of the inter-frequency signal measurement performed by the UE, that is, the start time t1 of the SPS PDSCH resource is later than or equal to the start time of the measurement window t5 and the end time t2 of the SPS PDSCH resource is earlier than or equal to the end time t6 of the measurement window, the UE may stop the inter-frequency signal measurement on the SPS PDSCH resource having the first priority. The UE may perform the inter-frequency signal measurement on resources other than the SPS PDSCH resource. The base station can keep transmitting the downlink data within the window of the SPS PDSCH resource having the first priority, not avoiding the measurement window of the inter-frequency signal measurement.

In this way, with the method in accordance with embodiments of the disclosure, the UE can keep the downlink communication with the serving cell within the measurement window of the inter-frequency signal measurement, thereby reducing the situation that the downlink data transmission is stopped due to the inter-frequency signal measurement, reducing the transmission delay of the downlink data, and meeting the requirements of low-latency data transmission.

In some embodiments, the block 804 may include in response to determining that the time difference between the start time of the measurement window and the start time of one of the at least one first SPS PDSCH resource is less than or equal to the time length threshold, keeping the downlink communication with the UE during the time period between the start time of the measurement window and the start time of the one of the at least one first SPS PDSCH resource.

Here, the one of the at least one first SPS PDSCH resource may be any one of the at least one first SPS PDSCH resource within the measurement window, or may be the first one of the at least one first SPS PDSCH resource within the measurement window.

Since the receiver of the UE needs a certain handover time period for the handover between the carrier frequency of the serving cell and the carrier frequency of the inter-frequency cell, within is a time duration that the UE perform the carrier frequency handover once, when the time period between the start time of the measurement window and the start time of the first SPS PDSCH resource is less than the twice of the handover time period, the UE cannot return back to the carrier frequency of the serving cell during this time period, and thus the UE cannot complete the handover process. This results in useless handover operations and even delays in the downlink data transmission on the first SPS PDSCH resource. Therefore, in order to avoid the above situation, the base station may configure the time length threshold based on at least the handover time period. The time length threshold may be greater than or equal to the twice of the handover time period. In some examples, the base station can configure the time length threshold based on factors other than the carrier frequency handover time period of the UE. The other factors include, for example, resource configuration status of the system, global configuration of the base station, channel quality, and the like. Here, keeping the downlink communication with the serving cell may include that the receiver of the UE does not monitor the signal of the inter-frequency cell.

As illustrated in FIG. 4, the SPS PDSCH resource having the first priority is within the measurement window during which the UE performs the inter-frequency signal measurement and the time difference from the start time t5 of the measurement window to the start time t1 of the SPS PDSCH resource is less than or equal to the time length threshold. In the case that the inter-frequency signal measurement is performed between t5 and t1, since the UE needs to perform the carrier frequency handover twice, considering the time required for the inter-frequency signal measurement and the inter-frequency handover time period of the UE, it may be determined that the UE cannot switch to the carrier frequency of the serving cell for the downlink communication from the start time t5. Therefore, when the time difference between the start time t5 of the measurement window to the start time t1 of the SPS PDSCH resource is less than or equal to the time length threshold, the UE will keep receiving the downlink information in the serving cell during the time period from t5 to t1, without performing the inter-frequency signal measurement, and the UE can perform the inter-frequency signal measurement after the end time t2 of the transmission window.

In this way, happening of the case that the UE cannot switch to the carrier frequency of the serving cell timely from the start time of the SPS PDSCH resource caused by performing the handover between the carrier frequency of the inter-frequency cell and the carrier frequency of the serving cell before the first SPS PDSCH resource can be reduced. Therefore, the reliability of the downlink data reception during the transmission window can be improved and invalid carrier frequency handover can be reduced.

In some embodiments, the block 804 may include in response to determining that the time difference between the end time of the measurement window and the end time of one of the at least one first SPS PDSCH resource is less than or equal to the time length threshold, keeping the downlink communication with the UE during the time period between the end time of the one of the at least one first SPS PDSCH resource and the end time of the measurement window.

Here, the one of the at least one first SPS PDSCH resource may be any one or the last one of the at least one first SPS PDSCH resource within the measurement window.

In the case that the time period between the end time of the measurement window and the end time of the SPS PDSCH resource is less than or equal to the time length threshold, since the UE needs to perform the carrier frequency handover twice, after performing inter-frequency signal measurement within this time period, it is determined that there is no enough time for the UE to switch to the carrier frequency of the serving cell at the end of the measurement window. Therefore, the UE can keep receiving the downlink information in the serving cell during this window, without performing inter-frequency signal measurement.

As illustrated in FIG. 5, the SPS PDSCH resource is within the measurement window during which the UE performs the inter-frequency signal measurement and the time period from the end time t2 of the SPS PDSCH resource to the end time t6 of the measurement window is less than or equal to the time length threshold. If the inter-frequency signal measurement is performed from t2 to t6, since the UE needs to perform the carrier frequency handover twice, considering the time period occupied by the inter-frequency signal measurement and the inter-frequency handover time period of the UE, it can be determined that the UE cannot switch to the carrier frequency of the serving cell at t6. Therefore, when the time period from the end time t2 of the SPS PDSCH resource to the end time t6 of the measurement window is less than or equal to the inter-frequency handover time period of the UE, the UE can keep receiving the downlink information in the serving cell from t2 to t6, and does not perform the inter-frequency signal measurement.

In this way, the happening of the case that the UE cannot switch to the carrier frequency of the serving cell timely for the downlink communication after the end of the measurement window caused by performing the inter-frequency signal measurement and the downlink communication handover from the end time of the measurement window to the end time of the SPS PDSCH resource. In addition, the invalid carrier frequency handover can be reduced.

In some embodiments, the block 804 may include in response to determining that a time period between two adjacent first SPS PDSCH resources of at least two first SPS PDSCH resources within the measurement window is less than or equal to the time length threshold, keeping the downlink communication with the UE during the time period.

There may be two or more SPS PDSCH resources within one measurement window. During the time period between two adjacent SPS PDSCH resources, if it needs to perform the inter-frequency signal measurement, the UE needs to switch from the carrier frequency of the serving cell to the carrier frequency of the inter-frequency cell, performs the inter-frequency signal measurement, and switches from the carrier frequency of the inter-frequency cell to the carrier frequency of the serving cell for the downlink communication. Therefore, the UE requires a certain handover time period. The UE or the base station may set the time length threshold to be greater than or equal to the handover time period. If the time period left for the UE to perform the carrier frequency handover twice is less than or equal to the time length threshold, it is determined that the UE cannot complete the carrier frequency handover twice when the time period ends. Therefore, if the time period between two SPS PDSCH resources is less than or equal to the time length threshold, the UE keeps the downlink communication with the serving cell, i.e., not performing the inter-frequency signal measurement.

As illustrated in FIG. 6, multiple SPS PDSCH resources are within the measurement window during which the UE performs the inter-frequency signal measurement. In the two adjacent SPS PDSCH resources, the time period from the end time t2 of the earlier SPS PDSCH resource to the start time t3 of the later SPS PDSCH resource is less than or equal to the time length threshold. If the inter-frequency signal measurement is performed between t2 and t3, considering the time period occupied by the inter-frequency signal measurement and the time period of performing the carrier frequency handover twice by the UE, it can be determined that the UE cannot switch to the carrier frequency of the serving cell for the downlink communication at t3. Therefore, the UE can keep receiving downlink information in the serving cell during the time period from t2 to t3, without performing the inter-frequency signal measurement.

In this way, the happening of the case that the UE cannot switch to the carrier frequency of the serving cell in time after the time period between the two adjacent SPS PDSCH ends caused by performing the handover between the carrier frequency of the inter-infrequency cell and the carrier frequency of the serving cell during the time period between the two adjacent SPS PDSCH resources. At the same time, invalid carrier frequency handover can be reduced.

As illustrated in FIG. 7, there are two SPS PDSCH resources within the measurement window during which the UE performs the inter-frequency signal measurement.

In FIG. 7, X represents the time period from the start time of a first one of the transmission windows occupied by the two SPS PDSCH resources to the start time of the measurement window. In the case that X is less than or equal to the time length threshold, the inter-frequency signal measurement is performed after the first transmission window. That is, the UE keeps the downlink communication with the serving cell within the time period X, without performing the inter-frequency signal measurement.

In FIG. 7, Y represents the time period from the end time of the first one of the two SPS PDSCH resources to the start time of the second one of the two SPS PDSCH resources. In the case that Y is less than or equal to the time length threshold, the UE keeps the downlink communication with the serving cell during the time period Y, without performing the inter-frequency signal measurement.

In FIG. 7, Z represents the time period from the end time of the second one of the two SPS PDSCH resources to the end time of the measurement window. In the case that Z is less than or equal to the time length threshold, the inter-frequency signal measurement is not performed after the second SPS PDSCH resource. That is, the UE keeps the downlink communication with the serving cell during the time period Z, without performing the inter-frequency signal measurement.

In some embodiments, the time length threshold is greater than or equal to the time period that the UE performs the inter-frequency handovers twice.

In the process that the UE switches from the downlink signal received by the serving cell to the carrier frequency of the inter-frequency cell for the inter-frequency signal measurement and then to the downlink signal received by the serving cell, the receiver needs to switch from the carrier frequency of the serving cell to the carrier frequency of the inter-frequency cell, and the UE needs to configure the receiver. The time length threshold may be greater than or equal to the twice of the inter-frequency handover time period of the UE.

During the time period between two adjacent transmission windows, the UE needs to switch from the carrier frequency of the serving cell to the carrier frequency of the inter-frequency cell, performs the inter-frequency signal measurement, and switches from the carrier frequency of the inter-frequency cell to the carrier frequency of the serving cell. Therefore, the UE needs the twice of the inter-frequency handover time period. The time length threshold may be greater than or equal to the twice of the inter-frequency handover time period of the UE.

The time length threshold is greater than or equal to the time period that the UE performs the inter-frequency handover twice. It can be determined that the UE can complete the carrier frequency handover twice.

In this way, the time length threshold is used as the condition for determining whether to perform the handover between the carrier frequency of the inter-frequency cell and the carrier frequency of the serving cell, it may be accurately determined whether there is enough time for the UE to perform the carrier frequency handover between the inter-frequency cell and the serving cell. Therefore, invalid carrier frequency handover can be reduced and it can be ensured that the UE can switch to the carrier frequency of the serving cell for the data transmission within the transmission window or the UE can switch to the carrier frequency of the inter-frequency cell to perform the inter-frequency signal measurement within the measurement window.

In some embodiments, the data transmission method may further include receiving the capability information of the UE, determining the time length threshold based on the capability information, and sending indication information configured to indicate the time length threshold.

Here, the time length threshold may be determined by the base station and sent to the UE through the indication information.

The UE can send the capability information, such as the time period required for performing the carrier frequency handover by the UE, to the base station. The base station may determine the inter-frequency handover time period based on the reported capability information, and send the determined time length threshold to the UE. The base station can separately assign the time length threshold for a UE or assign the determined time length threshold to multiple UEs.

In some embodiments, the inter-frequency signal measurement includes reference signal measurement performed by the UE on the inter-frequency cell, and/or SSB monitoring performed by the UE on the inter-frequency cell.

The measurement window during which the UE performs the inter-frequency signal measurement on the inter-frequency cell includes the measurement gap during which the UE performs the reference signal measurement on the inter-frequency cell and/or the duration window during which the UE performs the SSB monitoring on the inter-frequency cell.

Here, the reference signal measurement may be that the UE measures the reference signal of the inter-frequency cell when performing mobility measurement. The UE may measure the reference signal of the inter-frequency cell at intervals. The base station may configure the periodic measurement gap for the UE. The UE may stop measuring the reference signal when performing the downlink SPS data transmission having the first priority.

The base station may configure the periodic duration window for the UE to monitor the SSB of the inter-frequency cell. The UE can stop monitoring the SSB of the inter-frequency cell when performing the downlink SPS data transmission having the first priority.

In some embodiments, the first SPS PDSCH resource having the first priority includes the high-priority SPS PDSCH resource configured through the RRC signaling.

Here, the base station can configure the SPS PDSCH resource to have the first priority through the RRC signaling. Here, the first priority may be the highest priority, or the first priority may be a priority higher than a preset priority threshold.

For example, the URLLC service has high requirements on the low latency. Therefore, the SPS PDSCH resource used for the downlink data transmission of the URLLC service may be determined to have the first priority. The base station may send the downlink SPS PDSCH resource configuration information and the priority information corresponding to the downlink SPS PDSCH configuration to the UE through the RRC signaling. When the transmission window occupied by the SPS PDSCH resource having the first priority is within the measurement window, the downlink data transmission of the downlink SPS PDSCH having the first priority is performed. In this way, the time latency of the downlink data of the URLLC service can be reduced, and the latency requirements of the downlink data transmission of the URLLC service is satisfied.

In some embodiments, the method further includes determining second scheduling information associated with a second SPS PDSCH resource, in which the second scheduling information is configured to indicate a second SPS PDSCH resource configured with a second priority and the first priority is higher than the second priority, determining, based on the measurement information and the second scheduling information, that the second SPS PDSCH resource overlaps the measurement window in the time domain; and in response to determining that the second SPS PDSCH resource overlaps the measurement window in the time domain, stopping the downlink communication with the UE on an overlapping portion where the second SPS PDSCH resource overlaps the measurement window in the time domain.

In some embodiments, keeping the inter-frequency signal measurement on the overlapping portion where the second SPS PDSCH resource overlaps the measurement window in the time domain includes stopping the downlink communication with the serving cell on the overlapped portion where the second SPS PDSCH resource overlaps the measurement window in the time domain.

The base station may stop the downlink communication with the UE on the overlapping portion where the second SPS PDSCH resource overlaps the measurement window in the time domain.

The UE may not use the second SPS PDSCH resource to perform the downlink communication with the serving cell when performing the inter-frequency signal measurement within the measurement window.

In this way, the completion of the inter-frequency signal measurement can be within the measurement window can be ensured, and at the same time, the flexible configuration for the high-priority SPS PDSCH resource and the low-priority SPS PDSCH resource in the inter-frequency signal measurement scenario is achieved.

In some embodiments, the first SPS PDSCH resource is scheduled for a first communication service type. The first communication service type has a higher priority than a second communication service type.

For example, the priority of the URLLC service type is higher than the priority of the mMTC type, such that the first SPS PDSCH resource may be scheduled for the URLLC service type.

In this way, the service data with the higher priority can be not affected by the inter-frequency signal measurement, to reduce the time latency.

A specific example is provided below in conjunction with any of the above-mentioned embodiments.

This example is related to a method for transmitting data within the measurement gap/SSB measurement time configuration duration (SMTC duration) window.

When the priority parameter of the downlink SPS PDSCH resource is configured as a high priority, within the measurement gap, if there is a transmission opportunity of the SPS PDSCH resource, the UE needs to interrupt the inter-frequency signal measurement and return to the carrier frequency of the serving cell to receive the downlink data transmitted by the SPS PDSCH resource, and perform the inter-frequency signal measurement after the reception of the downlink data is completed.

Considering that the receiver of the UE needs handover time period to perform the handover between the carrier frequency of the serving cell and the carrier frequency of the inter-frequency cell, the following solutions are also available.

1. When the time interval between the start time of the measurement gap and the start time of the transmission window occupied by the first one of the SPS PDSCH resources within the measurement gap is equal to or less than 2T, the UE performs the inter-frequency signal measurement after the transmission window occupied by the first one of the SPS PDSCH resources ends.

2. When the time interval between the end time of transmission window occupied by the last one of the SPS PDSCH resources within the measurement gap and the end time of the measurement gap is equal to or less than 2T, the UE will not perform the inter-frequency signal measurement after the transmission window occupied by the last one of the SPS PDSCH resources, but keeps receiving the downlink information of the serving cell.

3. When there are multiple transmission windows occupied by the SPS PDSCH resources within the measurement gap and the time interval between the transmission windows occupied by the two adjacent SPS PDSCH resources is equal to or less than 2T, the UE keeps the downlink communication with the serving cell and not perform the inter-frequency signal measurement between the transmission windows occupied by the two adjacent SPS PDSCH resources.

The above T is the handover time period required for performing the handover between the carrier frequencies by the receiver of the UE. The value of T is related to the capacity of the UE. The base station may configure the value of T for the UE after the UE reports the capability information of the UE. For example, the value of T can be configured as 0.5 ms.

Since the transmission window occupied by the SPS PDSCH resource and the measurement window are configured in advance by the base station using the RRC signaling, both the base station and the UE can predict the time relationship between the transmission window and the measurement window in advance.

As illustrated in FIG. 7. The UE configures the high-priority SPS PDSCH resource. In FIG. 7, if x is equal to or less than 2T, the UE will not perform the inter-frequency signal measurement after the measurement gap configured by the base station starts, and keep the downlink communication with the serving cell. That is, within the time period corresponding to x, the UE will not perform the inter-frequency signal measurement.

If y is greater than 2T, within the time period corresponding to y, the UE will perform the inter-frequency signal measurement.

If z is greater than 2T, the inter-frequency signal measurement will be performed again after the transmission window 2. That is, within the time period corresponding to z, the UE will perform the inter-frequency signal measurement.

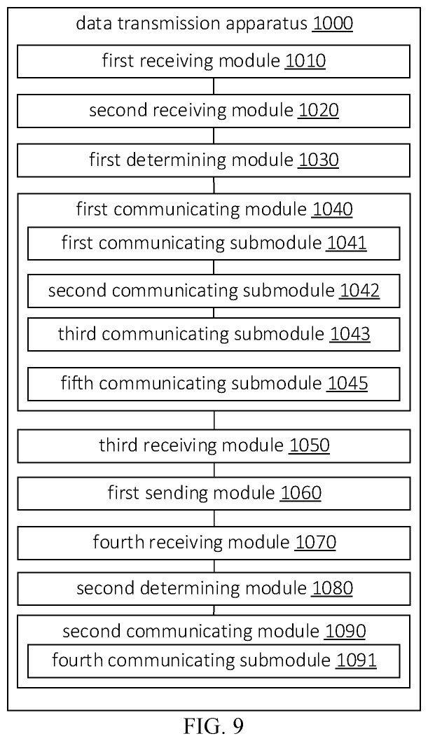

Embodiments of the disclosure further provides a data transmission apparatus, which is integrated into a UE of a wireless communication. FIG. 9 is a schematic diagram illustrating a data transmission apparatus 1000 in accordance with an embodiment of the disclosure. As illustrated in FIG. 9, the apparatus 1000 includes a first receiving module 1010, a second receiving module 1020, a first determining module 1030 and a first communicating module 1040.

The first receiving module 1010 is configured to receive measurement information associated with inter-frequency signal measurement. The measurement information is configured to indicate at least one measurement window.

The second receiving module 1020 is configured to receive first scheduling information associated with a first semi-persistent scheduling (SPS) physical downlink shared channel (PDSCH) resource. The first scheduling information is configured to indicate the first SPS PDSCH resource configured with a first priority.

The first determining module 1030 is configured to determine, based on the measurement window and the first scheduling information, whether the first SPS PDSCH resource overlaps the measurement window in the time domain.

The first communicating module 1040 is configured to, in response to determining that the first SPS PDSCH resource overlaps the measurement window in the time domain, keep a downlink communication with the serving cell at least during a window of the first SPS PDSCH resource.

In some embodiments, the inter-frequency signal measurement includes reference signal measurement performed by the UE on an inter-frequency cell, and/or the synchronization signal block (SSB) monitoring performed by the UE on the inter-frequency cell.

In some embodiments, the first communicating module 1040 includes a first communicating submodule 1041.

The first communicating submodule 1041 is configured to determine that a time difference between a start time of the measurement window and a start time of one of the at least one first SPS PDSCH resource is less than or equal to a time length threshold; keep the downlink communication with the serving cell during the time period between the start time of the measurement window and the start time of one of the at least one first SPS PDSCH resource; and performing the inter-frequency signal measurement after the window of the one of the at least one first SPS PDSCH resource ends.

In some embodiments, the first communicating module 1040 includes a second communicating submodule 1042.

The second communicating submodule 1042 is configured to determine that a time difference between an end time of one of the at least one first SPS PDSCH resource and an end time of the measurement window is less than or equal to the time length threshold; and keep the downlink communication with the serving cell within the time period between the end time of one of the at least one first SPS PDSCH resource and the end time of the measurement window.

In some embodiments, the first communicating module 1040 includes a third communicating submodule 1043.

The third communicating submodule 1043 is configured to determine that a time interval between two adjacent first SPS PDSCH resources in at least two first SPS PDSCH resources within the measurement window is less than or equal to the time length threshold; and keep the downlink communication on the serving cell during the time interval.

In some embodiments, the time length threshold is greater than or equal to a time period of performing the inter-frequency handover twice by the UE.

In some embodiments, the apparatus 1000 further includes a third receiving module 1050.

The third receiving module 1050 is configured to receive indication information configured to indicate the time length threshold.

In some embodiments, the apparatus 1000 further includes a first sending module 1060.

The first sending module 1060 is configured to report capability information of the UE. The capability information is used for the base station to determine the time length threshold.

In some embodiments, the apparatus 1000 further includes a fourth receiving module 1070, a second determining module 1080, and a second communicating module 1090.

The fourth receiving module 1070 is configured to receive second scheduling information associated with a second SPS PDSCH resource. The second scheduling information is configured to indicate a second SPS PDSCH resource configured with a second priority. The first priority is higher than the second priority.

The second determining module 1080 is configured to determine, based on the measurement information and the second scheduling information, that the second SPS PDSCH resource overlaps the measurement window in the time domain.

The second communicating module 1090 is configured to, in response to determining that the second SPS PDSCH resource overlaps the measurement window in the time domain, keep the inter-frequency signal measurement on an overlapping portion where the second SPS PDSCH resource overlaps the measurement window in the time domain.

In some embodiments, the second communicating module 1090 includes the fourth communicating module 2100.

The fourth communicating submodule 1091 is configured to stop the downlink communication with the serving cell on the overlapping portion where the second SPS PDSCH resource overlaps the measurement window in the time domain.

In some embodiments, the first SPS PDSCH resource is scheduled for a first communication service type. The first communication service type having a higher priority than the second communication service type.

In some embodiments, the first SPS PDSCH resource is configured to have the first priority through the RRC signaling.

In some embodiments, the first communicating module 1040 includes a fifth communicating submodule 1045.

The fifth communicating submodule 1045 is configured to at least stop the inter-frequency signal measurement on the overlapping portion where the first SPS PDSCH resource overlaps the measurement window in the time domain.

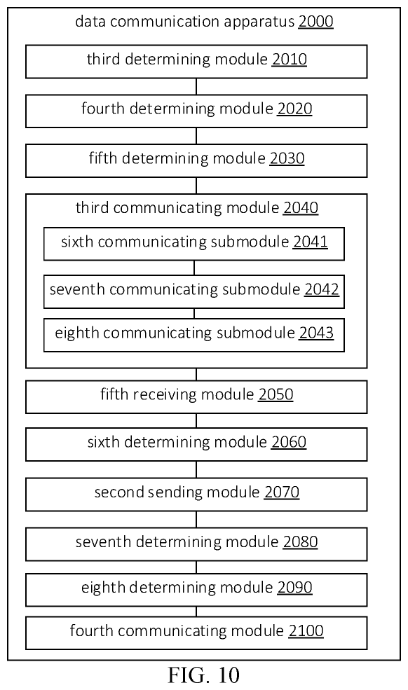

Embodiment of the disclosure further provides a data transmission apparatus, which is integrated in a base station of a wireless communication. FIG. 10 is a schematic diagram illustrating a data transmission apparatus 2000 in accordance with an embodiment of the disclosure. As illustrated in FIG. 10, the apparatus 2000 includes a third determining module 2010, a fourth determining module 2020, a fifth determining module 2030 and a third communicating module 2040.

The third determining module 2010 is configured to determine measurement information associated with inter-frequency signal measurement. The measurement information is configured to indicate at least one measurement window.

The fourth determining module 2020 is configured to determine first scheduling information associated with a first semi-persistent scheduling (SPS) physical downlink shared channel (PDSCH) resource. The first scheduling information is configured to indicate the first SPS PDSCH resource configured with a first priority.

The fifth determining module 2030 is configured to determine, based on the measurement window and the first scheduling information, that the first SPS PDSCH resource overlaps the measurement window in the time domain.

The third communicating module 2040 is configured to, in response to determining that the first SPS PDSCH resource overlaps the measurement window in the time domain, keep downlink communication with the UE at least during a window of the first SPS PDSCH resource.

In some embodiments, the third communicating module 2040 includes a sixth communicating submodule 2041.

The sixth communicating submodule 2041 is configured to determine that a time difference between a start time of the measurement window and a start time of one of the at least one first SPS PDSCH resource is less than or equal to a time length threshold; and keep the downlink communication with the UE during a time period between the start time of the measurement window and the start time of the one of the at least one first SPS PDSCH.

In some embodiments, the third communicating module 2040 includes a seventh communicating submodule 2042.

The seventh communicating submodule 2042 is configured to determine that a time difference between an end time of the measurement window and an end time of one of at least one first SPS PDSCH resource is less than or equal to the time length threshold; and keep the downlink communication with the UE during the time period between the end time of the measurement window and the end time of the one of the at least one first SPS PDSCH resource.

In some embodiments, the third communicating module 2040 includes an eighth communicating submodule 2043.

The eighth communicating submodule 2043 is configured to determine that a time interval between the two adjacent first SPS PDSCH resources of at least two first SPS PDSCH resources within the measurement window is less than or equal to the time length threshold; and keep the downlink communication with the UE during the time interval.

In some embodiments, the time length threshold is greater than or equal to a time period of performing the inter-frequency handover twice by the UE.

In some embodiments, the apparatus 2000 further includes a fifth receiving module 2050, a sixth determining module 2060, and a second sending module 2070.

The fifth receiving module 2050 is configured to receive capability information of the UE.

The sixth determining module 2060 is configured to determine the time length threshold based on the capability information.

The second sending module 2070 is configured to send indication information configured to indicate the time length threshold.

In some embodiments, the inter-frequency signal measurement includes reference signal measurement performed by UE on an inter-frequency cell, and/or synchronization signal block (SSB) monitoring performed by the UE on the inter-frequency cell.

In some embodiments, the first SPS PDSCH resource having the first priority includes a high-priority SPS PDSCH resource configured through a radio resource control (RRC) signaling.

In some embodiments, the apparatus 2000 further includes a seventh determining module 2080, an eighth determining module 2090, and a fourth communicating module 2100.

The seventh determining module 2080 is configured to determine second scheduling information associated with a second SPS PDSCH resource. The second scheduling information is configured to indicate the second SPS PDSCH resource configured with a second priority. The first priority is higher than the second priority.

The eighth determining module 2090 is configured to determine, based on the measurement information and the second scheduling information, that the second SPS PDSCH resource overlaps the measurement window in the time domain.

The fourth communicating module 2100 is configured to, in response to determining that the second SPS PDSCH resource overlaps the measurement window in the time domain, stop the downlink communication with the UE on an overlapping portion where the second SPS PDSCH resource overlaps the measurement window in the time domain.

In some embodiments, the first SPS PDSCH resource is scheduled for a first communication service type. The first communication service type has a higher priority than a second communication service type.

In some embodiments, the first receiving module 1010, the second receiving module 1020, the first determining module 1030, the first communicating module 1040, the third receiving module 1050, the fourth receiving module 1070, the first sending module 1060, the fifth receiving module 2050, the second determining module 1080, the second communicating module 1090, the third determining module 2010, the fourth determining module 2020, the fifth determining module 2030, the third communicating module 2040, the sixth receiving module 2060, the sixth determining module 2060, the second sending module 2070, the seventh determining module 2080, the eighth determining module 2090, and the fourth communicating module 2100 can be implemented as one or more central processing units (CPU), graphics processing unit (GPU), baseband processor (BP), Application Specific Integrated Circuit (ASIC), DSP, Programmable Logic Device (PLD), Complex Programmable Logic Device (CPLD), Field-Programmable Gate Array (FPGA), general-purpose processor, controller, Micro Controller Unit (MCU), Microprocessor, or other electronic components for performing the aforementioned method.

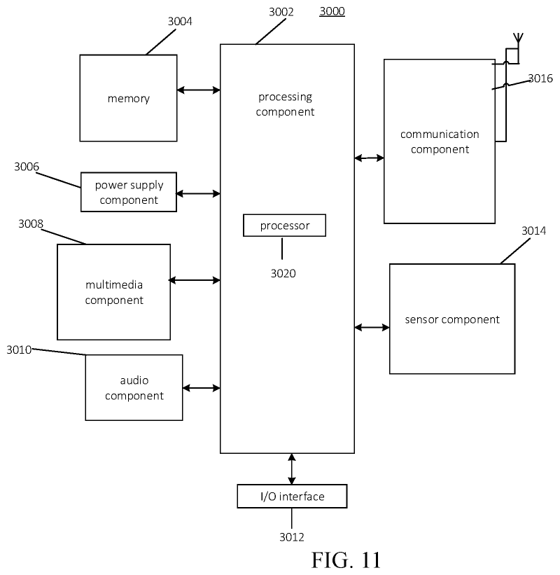

FIG. 11 is a block diagram illustrating a data transmission apparatus 3000 in accordance with an embodiment of the disclosure. For example, the apparatus 3000 may be a mobile phone, a computer, a digital broadcast terminal, a messaging device, a game console, a tablet device, a medical device, a fitness device, a personal digital assistant, and the like.

As illustrated in FIG. 11, the apparatus 3000 may include one or more of the following components: a processing component 3002, a memory 3004, a power supply component 3006, a multimedia component 3008, an audio component 3010, an input/output (I/O) interface 3012, a sensor component 3014, and a communication component 3016.

The processing component 3002 generally controls the overall operation of the apparatus 3000, such as operations associated with display, phone calls, data communications, camera operations, and recording operations. The processing component 3002 can include one or more processors 3020 to execute instructions to perform all or some of the steps of the methods described above. Additionally, the processing component 3002 may include one or more modules that facilitate the interaction between processing component 3002 and other components. For example, the processing component 3002 may include a multimedia module to facilitate the interaction between the multimedia component 3008 and the processing component 3002.

The memory 3004 is configured to store various types of data to support operations of the apparatus 3000. Examples of such data include instructions for operating any application or method on the apparatus 3000, contact data, phonebook data, messages, pictures, videos, and the like. The memory 3004 may be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 3006 provides power to various components of the apparatus 3000. The power supply components 3006 may include a power management system, one or more power supplies, and other components associated with generating, managing, and distributing power to the apparatus 3000.

The multimedia component 3008 includes a screen that provides an output interface between the apparatus 3000 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor can sense not only the boundaries of a touch or swipe action, but also the duration and pressure associated with the touch or swipe action. In some embodiments, the multimedia component 3008 includes a front-facing camera and/or a rear-facing camera. When the apparatus 3000 is in an operation mode, such as a shooting mode or a video mode, the front-facing camera and/or the rear-facing camera may receive external multimedia data. Each of the front-facing and rear-facing cameras can be a fixed optical lens system or have focal length and optical zoom capability.

The audio component 3010 is configured to output and/or input audio signals. For example, the audio component 3010 includes a microphone (MIC) that is configured to receive external audio signals when the apparatus 3000 is in operating modes, such as call mode, recording mode, and voice recognition mode. The microphone is configured to receive external audio signals. The received audio signal may be further stored in the memory 3004 or transmitted via the communication component 3016. In some embodiments, the audio component 3010 also includes a speaker for outputting the audio signals.

The I/O interface 3012 is configured to provide an interface between the processing component 3002 and a peripheral interface module. The peripheral interface module may be a keyboard, a click wheel, a button, and the like. These buttons may include, but are not limited to, home button, volume buttons, start button, and lock button.

The sensor component 3014 includes one or more sensors for providing status assessment of various aspects of the apparatus 3000. For example, the sensor component 3014 can detect the on/off state of the apparatus 3000, the relative positioning of components, such as the display and keypad of the apparatus 3000. The sensor component 3014 can also detect a change in the position of the apparatus 3000 or a component of the apparatus 3000, the presence or absence of contact with the apparatus 3000, the orientation or acceleration/deceleration of the apparatus 3000 and the temperature change of the apparatus 3000. The sensor component 3014 may include a proximity sensor configured to detect the presence of nearby objects in the absence of any physical contact. The sensor component 3014 may also include a light sensor, such as a CMOS or CCD image sensor, for use in imaging applications. In some embodiments, the sensor component 3014 may also include an acceleration sensor, a gyroscope sensor, a magnetic sensor, a pressure sensor, or a temperature sensor.

The communication component 3016 is configured to facilitate wired or wireless communication between the apparatus 3000 and other devices. The apparatus 3000 may access a wireless network based on a communication standard, such as Wi-Fi, 2G or 3G, or a combination thereof. In some examples, the communication component 3016 receives broadcast signals or broadcast related information from an external broadcast management system via a broadcast channel. In some examples, the communication component 3016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In some examples, the apparatus 3000 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component implementation for performing the above method.

In some embodiments, there is also provided a non-transitory computer-readable storage medium including instructions, such as a memory 3004 including instructions, which are executable by the processor 3020 of the apparatus 3000 to perform the above method. For example, the non-transitory computer-readable storage medium may be ROM, random access memory (RAM), CD-ROM, magnetic tape, floppy disk, optical data storage device, and the like.

Other implementations of the disclosure will be readily got by those skilled in the art upon consideration of the specification and practice of the disclosure. This disclosure is intended to cover any variations, uses, or adaptations of embodiments that follow the general principles of the embodiments and include those common design and conventional technical means that are not disclosed herein. The specification and examples are to be regarded as examples only, with the true scope and spirit of embodiments of the disclosure being indicated by the following claims.

It is understandable that the embodiments of the disclosure are not limited to the precise structures described above and illustrated in the accompanying drawings and that various modifications and changes may be made without departing from the scope thereof. The scope of embodiments of the disclosure is limited only by the appended claims.

1. A data transmission method, comprising:
receiving measurement information associated with an inter-frequency signal measurement, wherein the measurement information is configured to indicate at least one measurement window;
receiving first scheduling information associated with a first semi-persistent scheduling (SPS) physical downlink shared channel (PDSCH) resource, wherein the first scheduling information is configured to indicate the first SPS PDSCH resource configured with a first priority;
determining that the first SPS PDSCH resource overlaps the measurement window in time domain based on the measurement information and the first scheduling information; and
keeping downlink communication with a serving cell at least on a window of the first SPS PDSCH resource in response to determining that the first SPS PDSCH resource overlaps the measurement window in the time domain.

2. The method of claim 1, wherein the inter-frequency signal measurement comprises:
reference signal measurement performed by a user equipment (UE) on an inter-frequency cell; and/or
synchronized signal block (SSB) monitoring performed by the UE on the inter-frequency cell.

3. The method according to claim 1, wherein keeping the downlink communication with the serving cell at least on the window of the first SPS PDSCH resource comprises:
determining that a time difference between a start time of the measurement window and a start time of one of at least one SPS PDSCH resource is less than or equal to a time length threshold; keeping the downlink communication with the serving cell during a time period between the start time of the measurement window and the start time of the one of the at least one SPS PDSCH resource; and performing the inter-frequency signal measurement after a window of the one of the at least one SPS PDSCH resource ends; or
determining that a time difference between an end time of the measurement window and an end time of one of at least first SPS PDSCH resource is less than or equal to a time length threshold; and keeping the downlink communication with the serving cell within a time period between the end time of the one of the at least one SPS PDSCH resource and the end time of the measurement window; or
determining that a time interval between two adjacent SPS PDSCH resources of at least two SPS PDSCH resources within the measurement window is less than or equal to a time length threshold; and keeping the downlink communication with the serving cell within the time interval.

4. (canceled)

5. (canceled)

6. The method of claim 3, further comprising:
receiving indication information configured to indicate the time length threshold.

7. The method of claim 6, wherein the time length threshold is greater than or equal to a time period that the UE performs inter-frequency handover twice.

8. The method of claim 6, further comprising:
reporting capability information of the UE, wherein the capability information is used for a base station to determine the time length threshold.

9. The method of claim 1, further comprising:
receiving second scheduling information associated with a second SPS PDSCH resource, wherein the second scheduling information is configured to indicate the second SPS PDSCH resource configured with a second priority, and the first priority is higher than the second priority;
determining that the second SPS PDSCH resource overlaps the measurement window in the time domain based on the measurement information and the second scheduling information; and
in response to determining that the second SPS PDSCH resource overlaps the measurement window in the time domain, keeping the inter-frequency signal measurement on an overlapping portion where the second SPS PDSCH resource overlaps the measurement window in the time domain.

10. The method of claim 9, wherein keeping the inter-frequency signal measurement on the overlapping portion where the second SPS PDSCH resource overlaps the measurement window in the time domain comprises:
stopping the downlink communication with the serving cell on the overlapping portion where the second SPS PDSCH resource overlaps the measurement window in the time domain.

11. The method of claim 1, wherein the first SPS PDSCH resource is scheduled for a first communication service type, wherein the first communication service type has a higher priority than a second communication device type.

12. The method of claim 1, wherein the first SPS PDSCH resource is configured to have the first priority through a radio resource control (RRC) signaling.

13. The method of claim 1, wherein keeping the downlink communication with the serving cell on the first SPS PDSCH resource comprises:
at least stopping the inter-frequency signal measurement on an overlapping portion where the first SPS PDSCH resource overlaps the measurement window in the time domain.

14. A data communication method, comprising:
determining measurement information associated with inter-frequency signal measurement, wherein the measurement information is configured to indicate at least one measurement window;
determining first scheduling information associated with a first semi-persistent scheduling (SPS) physical downlink shared channel (PDSCH) resource, wherein the first scheduling information is configured to indicate the first SPS PDSCH resource configured with a first priority;
determining that the first SPS PDSCH resource overlaps the measurement window in time domain based on the measurement information and the first scheduling information; and
keeping downlink communication with a user equipment (UE) at least on a window of the first SPS PDSCH resource in response to determining that the first SPS PDSCH resource overlaps the measurement window in the time domain.

15. The method of claim 14, wherein keeping the downlink communication with the UE at least on the window of the first SPS PDSCH resource comprises:
determining that a time difference between a start time of the measurement window and a start time of one of at least one first SPS PDSCH resource is less than or equal to a time length threshold; and keeping the downlink communication with the UE during a time period between the start time of the measurement window and the start time of the one of the at least one first SPS PDSCH resource; or
determining that a time difference between an end time of the measurement window and an end time of one of at least first SPS PDSCH resource is less than or equal to a time length threshold; and keeping the downlink communication with the UE within a time period between the end time of the one of the at least one first SPS PDSCH resource and the end time of the measurement window; or
determining that a time interval between two adjacent first SPS PDSCH resources of at least two first SPS PDSCH resources within the measurement window is less than or equal to a time length threshold; and keeping the downlink communication with the UE within the time interval.

16. (canceled)

17. (canceled)

18. The method of claim 15, further comprising:
receiving capability information of the UE;
determining the time length threshold based on the capability information; and
sending indication information configured to indicate the time length threshold.

19. The method of claim 18, wherein the time length threshold is greater than or equal to a time period that the UE performs inter-frequency handover twice.

20. (canceled)

21. (canceled)

22. The method of claim 14, further comprising:
determining second scheduling information associated with a second SPS PDSCH resource, wherein the second scheduling information is configured indicate the second SPS PDSCH resource configured with a second priority, and the first priority is higher than the second priority;
determining that the second SPS PDSCH resource overlaps the measurement window in time domain based on the measurement information and the second scheduling information; and
in response to determining that the second SPS PDSCH resource overlaps the measurement window in the time domain, stopping the downlink communication with the UE on an overlapping portion where the second SPS PDSCH resource overlaps the measurement window in the time domain.

23-46. (canceled)

47. A communication device, comprising a processor, a transceiver, a memory, and a program stored on the memory and executable by the processor, wherein when the processor runs the program, the processor is configured to perform a data transmission method of claim 1.

48. A non-transitory computer-readable storage medium, having an executable program stored thereon, wherein when the executable program is performed by a processor, a data transmission method of claim 1.

49. A communication device, comprising a processor, a transceiver, a memory, and a program stored on the memory and executable by the processor, wherein when the processor runs the program, the processor is configured to:
determine measurement information associated with inter-frequency signal measurement, wherein the measurement information is configured to indicate at least one measurement window;
determine first scheduling information associated with a first semi-persistent scheduling (SPS) physical downlink shared channel (PDSCH) resource, wherein the first scheduling information is configured to indicate the first SPS PDSCH resource configured with a first priority;
determine that the first SPS PDSCH resource overlaps the measurement window in time domain based on the measurement information and the first scheduling information; and
keep downlink communication with a user equipment (UE) at least on a window of the first SPS PDSCH resource in response to determining that the first SPS PDSCH resource overlaps the measurement window in the time domain

50. A non-transitory computer-readable storage medium, having an executable program stored thereon, wherein when the executable program is performed by a processor, a data transmission method of claim 14.
